(19) United States
(12) Patent Application Publication
(10) Pub. No.: US 2024/0078587 A1
(43) Pub. Date: Mar. 7, 2024

(54) TOOTHBRUSH RECOMMENDATION APPARATUS AND CONTROL METHOD THEREFOR

(71) Applicant: MYUNGSUNG INC., Daegu (KR)

(72) Inventors: Myeong Yong KIM, Daegu (KR); Seong Hong, II, Gyeongsan-si (KR)

(21) Appl. No.: 18/272,560

(22) PCT Filed: Nov. 24, 2021
(86) PCT No.: PCT/KR2021/017418

§ 371 Date: Jul. 14, 2023

(30) Foreign Application Priority Data
Jan. 21, 2021 (KR) 10-2021-0008983
Nov. 11, 2021 (KR) 10-2021-0155118

(51) Int. Cl. G06Q 30/0601; A46B 9/00; A46B 9/04; A46B 9/06; A46D 1/00; G06Q 30/0203

(52) U.S. Cl. CPC G06Q 30/0631; A46B 9/005; A46B 9/04; A46B 9/06; A46D 1/02; G06Q 30/0203; A46B 2200/1066

(57) ABSTRACT

The present invention relates to a toothbrush type recommendation apparatus. The toothbrush type recommendation apparatus comprises: a user input unit; an output unit; and an operation control unit connected to the user input unit and the output unit. The operation control unit outputs a questionnaire to the output unit, the questionnaire including questions for determining the number of lines of bristles, questions for determining bristle strength, and questions for determining bristle shape, receives answers to the questionnaire as input from the user input unit and calculates a score for determining the number of lines of bristles and a score for determining bristle strength, determines the number of lines of bristles and the bristle strength corresponding to the respective calculated scores, determines a final bristle shape as a toothbrush type for the determined bristle strength on the basis of the answers to the questionnaire questions for determining bristle shape, and outputs the selected toothbrush type to the output unit.

### TECHNICAL FIELD

The present disclosure relates to a toothbrush recommendation apparatus and a control method therefor.

### BACKGROUND ART

Proper brushing habits are important for healthy teeth and oral hygiene. In addition to the proper brushing, it is also crucial to choose an appropriate toothbrush type based on a user's oral condition and brushing habits.

However, despite broadcasts and applications for guiding tooth brushing, there is no program to assists in selecting a toothbrush.

Therefore, most users arbitrarily select and use a toothbrush based on their experiences, habits, or prices.

In other words, due to the selection of a toothbrush without expertise, toothbrushing rather adversely affects the health of the gums or teeth.

### Technical Problem

Therefore, the technical problem to be achieved by the present disclosure is to recommend a toothbrush type suitable for a user.

Another technical problem to be achieved by the present disclosure is to notify a user of a toothbrush replacement timing.

### Technical Solution

A toothbrush type recommendation apparatus according to one aspect of the present disclosure includes: a user input unit, an output unit, and an operation control unit connected to the user input unit and the output unit and configured to: output questionnaires having a question for determining a number of lines of bristles, a question for determining a strength of the bristles, and a question for determining a bristle shape to the output unit; receive answers to the questionnaires from the user input unit to calculate a score for determining the number of lines of bristles and a score for determining a strength of the bristles; determine the number of lines of bristle and the bristle strength, which respectively corresponds to the calculated scores; with respect to the determined bristle strength, determine a final shape of bristles based on the answer to the questions for determining the shape of bristles in the questionnaires; and select the determined final shape as a toothbrush type; and output the selected toothbrush type to the output unit.

The number-of-lines-of-bristles determining questionnaire may include a question for determining the number of lines of bristles, the question associated with at least one of the following: an oral structure, age, gender, a height, and a weight, wherein the bristle strength determining questionnaire comprises a questions for determining a bristle strength, the question associated with the following: whether or not the user's age meets a condition of the set age, smoking, presence of at least one of calculus and plaque, bad breath, presence of abrasion in at least one of a cervical area and an apical area, presence of at least one of periodontal disease and dentin hypersensitivity, a number of brushing per day, an average brushing time, and whether there is an artificial tooth, and wherein the bristle shape determining questionnaire comprises a question for determining a bristle shape, the question associated with at least one of the following: presence of a crooked teeth, presence of a wisdom tooth, teeth scaling within one year, a loose tooth, bleeding gums, swollen gums, and whether the user's age meets a set age condition.

The operation control unit may calculate a score for determining the number of lines of bristles and a score for determining the bristle strength by summing up scores corresponding to respective answers to the question for determining the number of lines of bristles and the question for determining a bristle strength.

The operation control unit may calculate a score for determining the number of lines of bristles and determines the number of lines of bristles corresponding to the calculated score for determining the number of lines of bristles, calculate a score for determining a bristle strength and determine a bristle strength corresponding to the calculated score for determining a bristle strength, to determine the bristle strength having the determined number of lines of bristles, and determine the toothbrush type by selecting the bristle shape classified by the bristle strength selected based on answers to a questionnaire for determining a bristle shape.

The operation control unit may determine the number of lines of bristles as a first number of lines when the score for determining the number of lines of bristles is equal to or less than a first set value, determine the number of lines of bristles as a third number of lines greater than the first number of lines when the score for determining the number of lines of bristles is equal to or greater than a second set value greater than the first set value, and determine the number of lines of bristles as a second number of lines greater than the first number of lines and less than the third number of lines when the score for determining the number of lines of bristles is greater than the first set value and less than the second set value.

The operation control unit may determine the bristle strength as soft bristle when the score for determining the bristle strength is equal to or less than a set value, and the operation control unit may determine the bristle strength as hard bristle when the score for determining the bristle strength is greater than the set value.

When the bristle strength is determined as hard bristle, the operation control unit may select one of patterned bristles and elastic bristles as a toothbrush type according to presence of crooked teeth, presence of a wisdom tooth, and whether teeth scaling has been performed within one year.

The patterned bristles may include a first bristle having a shape in which a cylinder and a cone are combined and a second bristle having a shape in which a polyhedron and a polygonal pyramid are combined, and the elastic bristles may include a third bristle having a shape in which a cylinder and a cone are combined and a fourth bristle having a cylindrical shape.

When the bristle strength is determined as soft bristle, the operation control unit may determine one of fine bristles and micro bristles as a toothbrush type according to presence of sensitive tooth, presence of a loose tooth, presence of bleeding gums, presence of swollen gums, and whether a user's age meets a set age condition.

The fine bristles may include a bristle in which a cylinder and a cone are combined, and the micro bristles comprises a bristle having a cylindrical body and a plurality of tips.

The soft bristle may have a thickness equal to or less than a set value and have a circular cross section, and the hard bristle may have a thickness equal to or greater than the set value or has a polygonal cross section.

The operation control unit may an address of an online shopping mall selling the selected toothbrush type to the output unit.

A toothbrush type recommendation server according to another aspect of the present disclosure includes: a communication unit; and a server management unit connected to the communication unit and configured to calculate a usage period of a toothbrush based on a selected toothbrush type and teeth-and-oral-related information, calculate a toothbrush replacement date based on the calculated usage period, and when a current date reaches at a toothbrush replacement notification date calculated using the toothbrush replacement date, transmit a toothbrush replacement timing notification message to a user terminal of a customer through the communication unit.

When the current date does not reach the toothbrush replacement notification date, the server management unit may predict at least one tooth and oral disease with a high possibility of occurrence using the tooth and oral cavity related information, and transmit the predicted tooth and oral diseases to the user terminal using the communication unit.

The teeth-and-oral-related information may include at least one of the following: based on a selected bristle strength, a selected bristle shape, and a selected number of lines of bristles, a number of times a customer brushes teeth; an oral structure; presence of an artificial tooth; smoking; presence of at least one of calculus and plaque; bad breath; presence of abrasion in at least one of a cervical area and an apical area; presence of at least one of periodontal disease and dentin hypersensitivity; presence and degree of at least one of tooth decay and periodontal disease; presence and degree of at least one of calculus and plaque; and structure of an inner side of anterior teeth.

A control method for a toothbrush type recommendation apparatus according to yet another aspect of the present disclosure includes: outputting, by an operation control unit of a user terminal, questionnaires having a question for determining the number of lines of bristles, a question for determining a strength of the bristles, and a question for determining a bristle shape to an output unit; receiving, by the operation control unit, answers to the questionnaires from a user input unit to calculate a score for determining the number of lines of bristles and a score for determining a strength of the bristles; determining, by the operation control unit, the number of lines of bristle and the bristle strength, which respectively corresponds to the calculated scores; and determining, by the operation control unit, a final shape of bristles based on the answer to the question for determining the shape of bristles in the questionnaires with respect to the determined bristle strength and select the determined final shape as a toothbrush type; and outputting, by the operation control unit, the selected toothbrush type to the output unit.

The control method may further include: transmitting, by the operation control unit, each answer for the questionnaires, a calculated score for determining the number of lines of bristles, a calculated score for determining a bristle strength, a determined number of lines of brittles, a determined bristle strength, and a determined bristle shape, and a selected toothbrush type to a toothbrush type recommendation server as tooth and oral information through the communication unit.

The control method may further include: calculating, by a server management unit of the toothbrush type recommendation server, a usage period of the toothbrush based on a selected toothbrush type and teeth-and-oral-related information; calculating, by the server management unit, a toothbrush replacement date based on the calculated usage period; and when a current date reaches at a toothbrush replacement notification date calculated using the toothbrush replacement date, transmitting, by the server management unit, a toothbrush replacement timing notification message to the user terminal through the communication unit.

The control method may further include: predicting, by the server management unit, at least one highly potential tooth and oral disease based on the tooth- and oral-related information when the current date does not reach the toothbrush replacement notification date; and transmitting, by the server management unit, the predicted tooth and oral disease to the user terminal using the communication unit.

### Advantageous Effects

According to these features, a toothbrush type suitable for a user may be recommended according to the user's daily habit and oral condition, so that the user can use a toothbrush type suitable for the user, which is helpful in dental and oral care.

In addition, when the user wants to purchase the recommended toothbrush type, the user may be directly connected to an online shopping mall to conveniently and quickly purchase the toothbrush type, thereby greatly improving user convenience.

Additionally, since a toothbrush replacement timing and a highly potential disease may be guided using the user's daily habit and oral condition, thereby greatly helping the user's health.

### DESCRIPTION OF DRAWINGS

FIG. 1 is a schematic block diagram of a toothbrush recommendation apparatus according to an embodiment of the present disclosure.

FIG. 2A is a schematic block diagram of a user terminal shown in FIG. 1.

FIG. 2B is a schematic block diagram of the toothbrush type recommendation server shown in FIG. 1.

FIGS. 3A and 3B are data flow diagrams of a toothbrush recommendation apparatus according to an embodiment of the present disclosure.

FIG. 4 is a flowchart illustrating operations of a toothbrush type recommendation server for guiding a toothbrush replacement timing and a predicted disease in a toothbrush recommendation apparatus according to an embodiment of the present disclosure.

FIG. 5 is a diagram showing toothbrush types classified in a toothbrush recommendation apparatus according to an embodiment of the present disclosure.

FIG. 6 is a diagram showing toothbrush types classified in a toothbrush recommendation apparatus according to another embodiment of the present disclosure.

FIG. 7 is a diagram illustrating toothbrush types classified in a toothbrush recommendation apparatus according to yet another embodiment of the present disclosure.

FIGS. 8 to 11 are diagrams respectively showing a patterned bristle, an elastic bristle, a fine bristle, and a micro bristle of a toothbrush recommendation apparatus according to yet another embodiment of the present disclosure.

FIGS. 12A to 12E are diagrams illustrating an example of questionnaire for determining the number of lines of bristles, a bristle strength, and a bristle shape in a toothbrush recommendation apparatus according to an embodiment of the present disclosure.

FIGS. 13A and 13B are diagrams illustrating an example of result information output to an output unit in a toothbrush recommendation apparatus according to an embodiment of the present disclosure.

### MODE FOR CARRYING OUT THE INVENTION

Hereinafter, embodiments of the present disclosure will be described in detail with reference to the accompanying drawings, so that those skilled in the art can easily carry out the present disclosure. However, the present disclosure may be modified in various different ways, and the present disclosure is not limited to the described exemplary embodiments. Moreover, a part not related to the description will be omitted in order to clearly describe the present disclosure. Like reference numerals designate like elements throughout the specification.

It will be understood that when an element is referred to as being “connected” or “coupled” to another element, it can be directly connected or coupled to the other element or intervening elements may be present. In contrast, when an element is referred to as being “directly connected” or “directly coupled” to another element, it should be understood that there are no intervening elements.

Hereinafter, a toothbrush recommendation apparatus and a control method therefor according to an embodiment of the present disclosure will be described with reference to the accompanying drawings.

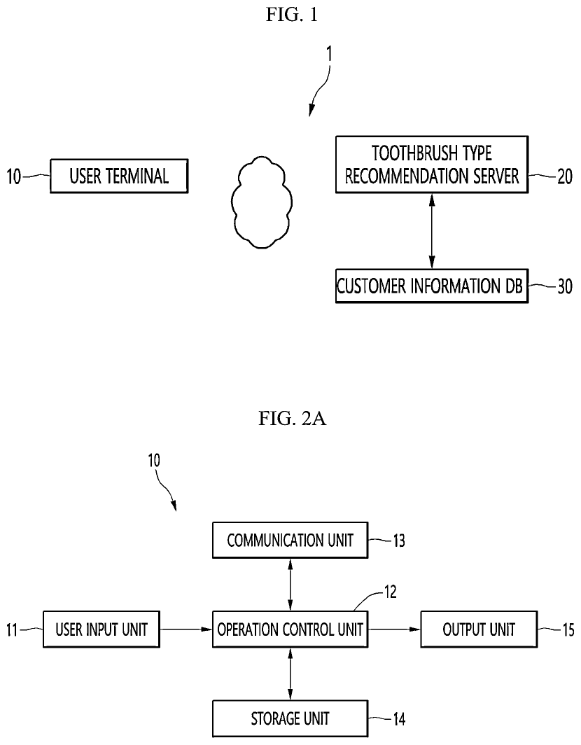

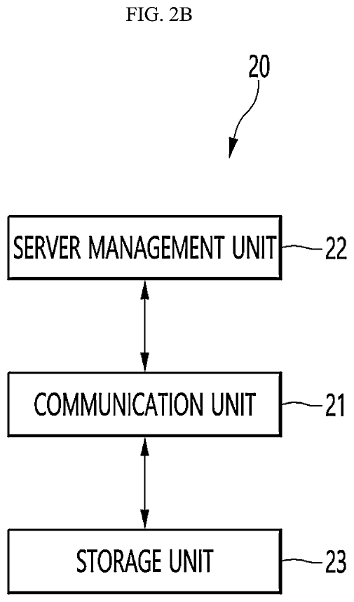

First, a toothbrush recommendation apparatus 1 according to an embodiment of the present disclosure will be described in detail with reference to FIGS. 1 to 2B.

Referring to FIG. 1, the toothbrush recommendation apparatus 1 of this example may include a user terminal 10, a toothbrush type recommendation server 20 communicating with the user terminal 10, and a customer information database (DB) 30.

The user terminal 10 is a terminal of a user who uses the toothbrush recommendation apparatus 1, and may be categorized into a mobile terminal and a stationary terminal depending on whether or not the terminal can be moved, and may be categorized into a handheld terminal, such as a smart phone or a tablet personal computer, and a vehicle mount terminal depending on whether a user can carry the terminal.

As shown in FIG. 2, the user terminal 10 may include a user input unit 11, an operation control unit 12 connected to the user input unit 11, a communication unit 13 connected to the operation control unit 12, and storage unit 14, and an output unit 15.

The components 1 to 15 shown in FIG. 2 are not essential, so the user terminal may further include at least one other component other than the components 11 to 15 or at least one of the components may be omitted.

The user input unit 11 may generate a signal related to an input operation, such as a user inputting a command for controlling operation of the user terminal 10, and output the signal to the operation control unit 12.

The user input unit 11 may include a key pad, a touch pad, a jog switch, a mouse, or the like.

The operation control unit 12 is a control unit that controls the overall operation of the user terminal 10, and may be a processor.

The operation control unit 12 may determine a user's selected operation using a signal input from the user input unit 11, and execute or control an operation corresponding to the determined operation. The operation of the operation control unit 12 will be described later in detail.

The communication unit 13 is for communication between the user terminal 10 and a communication system (not shown) or between the user terminal 10 and any other electronic device, and may include one or more modules.

For example, the communication unit 13 may include an internet module.

The Internet module refers to a module for wireless or wired Internet access, and the Internet module may be provided inside or outside the user terminal 10.

For an Internet scheme, wireless LAN (WLAN) (WiFi), wireless broadband (Wibro), world interoperability for microwave access (Wimax), high speed downlink packet access (HSDPA), or the like may be used.

However, in addition to the aforementioned Internet module, the communication unit 13 may further include other types of communication modules, such as a short-range communication module and a mobile communication module.

At this point, the short-range communication module is a module for short-range communication, and Bluetooth, RFID (Radio Frequency Identification), infrared communication (IrDA, infrared data association), UWB (Ultra Wideband), ZigBee, or the like may be used for a short-range communication scheme.

The mobile communication module may wirelessly transmit and receive signals (i.e., radio signals) to and from at least one of a base station, an external terminal, and a server over a mobile communication network. At this point, a radio signal may include a voice call signal, a video call signal, or any of various types of data according to transmission and reception of short messages or multimedia messages.

The storage unit 14 is a storage medium for storing data required for operation of the operation control unit 12 or data generated during the operation, and may be a memory.

The memory may be at least one of a RAM, a ROM, an EEPROM, a PROM, a magnetic memory, a magnetic disk, and an optical disk.

In an alternative example, the user terminal 10 may operate in association with a web storage that performs a storage function of the storage unit 14 over the Internet.

The output unit 15 may output an image corresponding to image data output from the operation control unit 12 to a screen in accordance with a control of the operation control unit 12.

Accordingly, the output unit 15 may include a display module, and in this case, the display module may display an image according to an operation of the toothbrush recommendation apparatus 1 and may display a user interface (UI), a graphic user interface (GUI), or the like according to the operation of the toothbrush recommendation apparatus 1.

Such a display module includes at least one display device from among a liquid crystal display, an organic light emitting diode display, a flexible display, and a 3D display.

However, the output unit 15 may generate audio and tactile outputs, and in this case, the output unit 15 may include a sound output module for outputting an audio or tactile output or a haptic module for generating vibration or the like.

The toothbrush type recommendation server 20 may provide an application that communicates with the user terminal 10 to provide the user terminal 10 an application for selecting a toothbrush type, and may select a toothbrush type using the user terminal 10.

As shown in FIG. 2B, the toothbrush type recommendation server 20 may include a server management unit 21, and a communication unit 22 and a storage unit 23 connected thereto.

The server management unit 21 may be a control unit that controls the overall operation of the toothbrush type recommendation server 20 and may also be a processor. This server management unit 21 may also be an operation control unit that controls the operation of the toothbrush type recommendation server 20.

As described above with reference to FIG. 2A, the communication unit 22 may be for communication with the user terminal 10 or any other external device and may include at least one communication module such as an Internet communication module.

The storage unit 23 may also be a memory, and may perform a function of storing data required for operation of the toothbrush type recommendation server and data generated during the operation.

The customer information database 30 may be a storage unit in which information on a user, that is, a customer, registered as a member of an application provided by the toothbrush type recommendation server 20 is stored.

Unlike FIG. 1, the customer information database 30 may be a component of the toothbrush type recommendation server 20, which constitutes a part of the toothbrush type recommendation server 20.

Customer information stored in the customer information database 30 may include customer personal information, which includes at least one of a user's identification (ID), password, name, gender, age, and contact information (e.g., phone number and email address), and may further include a teeth-related information which includes at least one of a daily habit and an oral care condition.

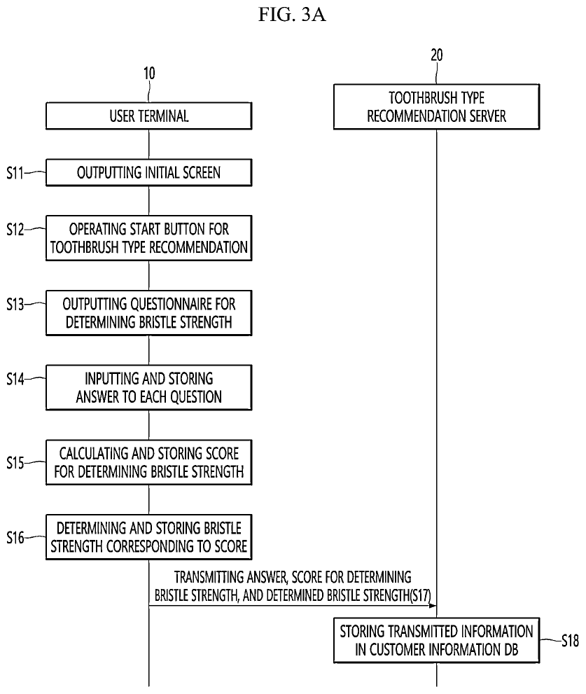

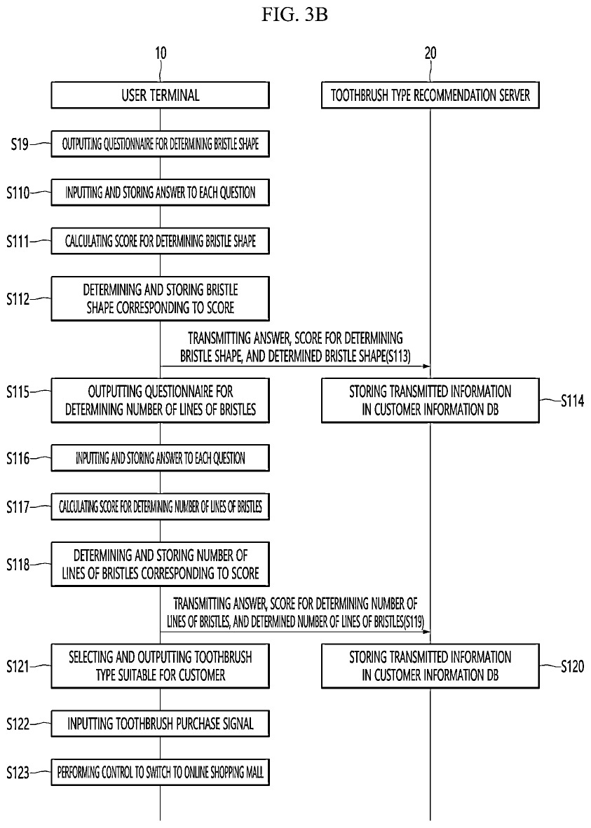

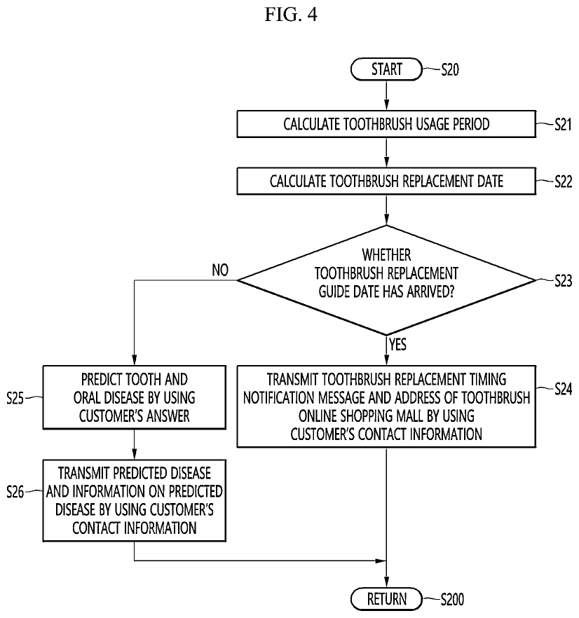

Next, operations of the toothbrush type recommendation apparatus 1 will be described with reference to FIGS. 3A to 4.

First, referring to FIGS. 3A and 3B, an operation of recommending a toothbrush type suitable for a user will be described.

In this example, the user terminal 10 has already accessed to the toothbrush type recommendation server 20 of this example through the communication unit 13 and has completed membership registration, and as a result, member information on the user of the user terminal 20 may be already stored in the customer information database 30.

At this point, the member information obtained through the membership registration may be customer personal information such as a member's name, contact information, address, identification information (ID), and password.

In addition, a toothbrush recommendation application for extracting a suitable toothbrush type may be installed in the user terminal 20, and an icon for executing the toothbrush recommendation application may be installed at the home screen of the user terminal 10.

At this point, the user terminal 10 may use the toothbrush recommendation application without a membership registration, and in this case, the user terminal 10 may access the toothbrush recommendation application or website to implement a toothbrush type recommendation operation.

Accordingly, the user may use the user terminal 10 to execute an execution icon or access a toothbrush recommendation app site or website.

When the corresponding application is installed in the user terminal 10, a user interface for using the corresponding application may also be installed in the user terminal 10.

At this point, data associated with the user interface may be stored in the storage unit 14 of the user terminal 10. Accordingly, questionnaires for determining a toothbrush type (e.g., toothbrush type determining questionnaires) may be stored in the storage unit 14 of the user terminal 10.

The toothbrush type determining questionnaires may include a bristle strength determining questionnaire, a bristle shape determining questionnaire, and a number-of-lines-of-bristles determining questionnaire.

Therefore, the toothbrush type recommendation apparatus 1 of this example may recommend a toothbrush type in consideration not only of a strength of bristle (i.e., a bristle strength) but also a shape of bristle (i.e., a bristle shape) and the number of lines of bristles (i.e., a bristle line number).

The bristle strength may be categorized into a regular bristle, an ultra-fine bristle ( [symbol] ), and mixed bristles which refer to a combination of the regular and ultra-fine bristles. At this point, the bristle strength may be determined by at least one of a thickness and material of one bristle. For example, a strength of the regular bristle may be greater than that of the ultra-fine bristle, and the strength of mixed bristles may be intermediate between the strength of regular bristle and the strength of the ultra-fine bristle.

The bristle shape may be categorized into a flat type and a centrifugal type.

The flat type indicates a case where a virtual plane formed by ends of bristles, that is, the ends of the bristles coming into direct contact with the teeth, is a flat surface, while the centrifugal type indicates a case where the virtual plane is a curved surface (e.g., a curved surface recessed toward a toothbrush head).

In addition, the number of lines of bristles may be categorized into 4 lines (e.g., a first number of lines), 5 lines (e.g., a second number of lines), and 6 lines (e.g., a third number of lines). At this point, the number of lines of bristles may be a maximum number of planting holes formed along a width direction of a toothbrush head having an approximately elliptical plane, so that a plurality of bristles is planted in the holes.

For example, the number of lines of bristles is categorized into three cases, such as 4 lines, 5 lines, and 6 lines, but not limited thereto, and the number of subdivided lines may be changed, and the number of subdivided lines may not be 4 lines, 5 lines, and 6 lines, but may be changed to different cases, such as 3 lines, 4 lines, and 5 lines.

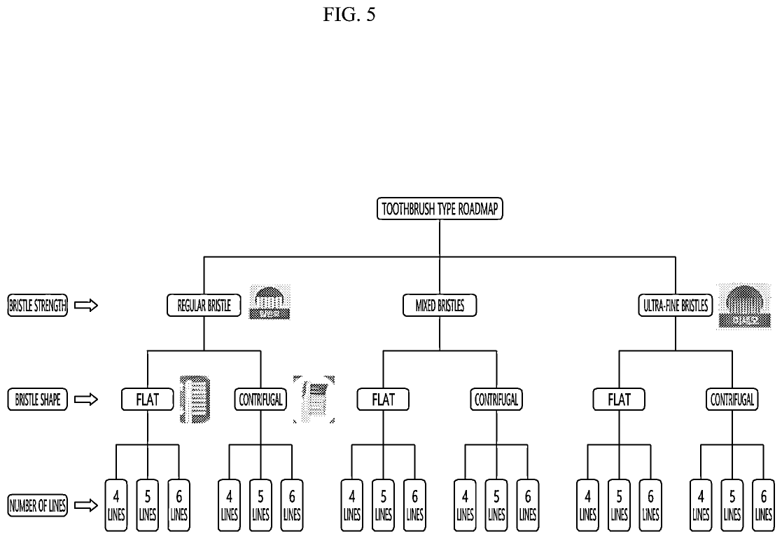

Therefore, in this example, the total number of recommendable toothbrushes having different types may be 18, as shown in FIG. 5. However, the number of recommendable types may also be changed according to the number of lines of bristles, the number of bristle shapes, and the number of bristle strengths.

Therefore, when the operation of the corresponding application starts through the user input unit 11, the operation control unit 12 of the user terminal 10 may display an initial screen to the output unit 15 using the data stored in the storage unit 14 (S11).

In this state, when a start button for toothbrush type recommendation is operated by the user input unit 11 (S12), the operation control unit 12 may read the toothbrush strength determining questionnaire from among the toothbrush type determining questionnaires stored in the storage unit 14 and may output the questionnaire on a question by question basis to the output unit 15 (S13).

The bristle strength determining questionnaire may contain questions for determining a bristle strength, with a total of 8 items to select.

For example, as shown in [Table 1], the bristle strength determining questionnaire may include at least one question of the following: whether an age of a user is less than or equal to/greater than a specified age (e.g., 65 years); whether the user is a smoker; whether there is any teeth impurity such as at least one of calculus and plaque; whether the user has bad breath; whether there is a sign of dental abrasion; whether there is an abnormal tooth such as at least one of gum disease and dentin hypersensitivity (gum disease/dentin hypersensitivity); whether the number of brushing per day is equal to/less than or greater than a preset number, for example less than 2 times per day, 3 times or more per day, or 5 times or more per day; and whether at least one of dental implant and denture is used. Among these questions, at least one may be omitted, and at least one another question may be added.

The dental abrasion may be, for example, abrasion present in at least one of a cervical area and apical area.

As already described above, numerical values such as 65 years old in determining age, 2 or less times, 3 or more times, and 5 or more times in determining the frequency of brushing are merely examples, but not limited thereto, and at least one of the numerical values may be changed to a different value.

Accordingly, in this example, factors for selecting a bristle strength may be at least one of age, smoking, dental impurities, bad breath, dental abrasion, an abnormal teeth condition, the frequency of brushing, and an artificial tooth.

The dental abrasion may be abrasion that takes place in at least one of the cervical area and apical area (cervical area/apical area).

In this case, scores are assigned for questions, so answering the questions leads to assignment of corresponding scores and a summed score may be calculated.

All numerical values, such as the numerical values of the scores presented below, are values corresponding to one example and may be changed as necessary.

TABLE 1

| | | | Regular | Mixed | Ultra-fine |
|---|---|---|---|---|---|
| Ranking | Division | Score | bristle | bristles | bristle |
| 1 | Gum disease/dentin | 30 | absent | present | serious |
| | hypersensitivity | | | | |
| 2 | Cervical/apical abrasion | 25 | absent | present | serious |
| 3 | Calculus/plaque | 20 | plenty | normal | few |
| 4 | Smoking | 5 | smoker | non-smoker | non-smoker |
| 5 | Frequency of brushing | 10 | less than 2 | 3 or more | more than 5 |
| | | | times/day | times/day | times/day |
| 6 | Dental implant/denture | 5 | absent | absent | absent |
| 7 | Bad breath | 3 | plenty | normal | few |
| 8 | Age | 2 | under 65 | above 65 | above 65 |

| | |
|---|---|
| Total | 100 |

At this point, plaque may be easily removed when the bristle strength is great, and when there is a lot of plaque, it may be better to use a bristles with greater strength.

As the bristle strength increases, abrasion of the cervical or apical area increases, and thus, for abrasion in the cervical or apical area, it may be preferable to select a bristle with low strength.

In the case of a periodontal disease such as gum inflammation and dentin hypersensitivity, using a toothbrush with greater strength may increase discomfort and worsen the symptoms, and thus, it is desirable to adjust the toothbrush bristle strength based on the severity of the periodontal disease and dentin hypersensitivity. Furthermore, the periodontal disease and dentin hypersensitivity are greatly influenced by the condition of the gums, hardness of a tooth, and an amount of exposed dentin, and thus, they may be significantly affected by the strength of the toothbrush bristle.

The more severe the plaque and staining, the worse the bad breath, so if the bad breath is persistent, it may be better to use a toothbrush with greater bristle strength, and smoking also tends to increase the bad breath, plaque, and staining so it may be better for a smoker to use a toothbrush with greater bristle strength.

Muscular strength, ability to perform precise brushing techniques, and the frequency of brushing may decrease with age, and thus, it may be beneficial to increase the bristle strength of the toothbrush with age to compensate for the diminished factors.

In addition, as the frequency of brushing increases, the wear of the teeth is affected, so if the frequency of brushing is high, it may be better to use a toothbrush with lower bristle strength.

On the other hand, in the case of an artificial tooth such as a dental implant or denture, there is no or little risk of teeth abrasion, so a bristle with high strength may be used for the dental implant or denture.

At this point, out of 100%, the mixed bristles is of the highest proportion (approximately 60%), while the regular bristle and the ultra-fine bristle are of the same proportion (e.g., 20%).

Therefore, the ultra-fine bristle may be selected when a summed score is between 80 and 100, the regular bristle may be selected when a summed score is between 0 and 20, and the mixed bristles may be selected when a summed score is between 21 and 79.

The selection proportion (e.g., 20% and 60%) and the range of summed scores (e.g., between 80-100, between 0-20, and between 21-79) for selecting the bristle strength described in this example are presented as an example, and thus, they are not limited thereto but may be changed to other values.

Accordingly, when a user selects all answers corresponding to the regular bristle for the respective questions, a selected bristle strength may be the regular bristle, and when the user selects all answers corresponding to the ultra-fine bristle for the respective questions, the selected bristle may be of course the ultra-fine bristle.

Therefore, the operation control unit 12 may output the corresponding questions to the output unit 15, receive an answer to each question from the user input unit 11, assign a predetermined score according to an input answer and store the assigned score in storage unit 14 (S14).

Therefore, when the question for determining the bristle strength in the bristle strength determining questionnaire is output to the output unit 15 and the answers to all questions and an answer completion signal are transmitted to the operation control unit 12 through the user input unit 11 by the user's operation, the operation control unit 12 may calculate a score for determining a bristle strength by summing up all the scores assigned according to the respective answers and then store the calculated score in the storage unit 14 (S15).

Next, the operation control unit 12 may compare the calculated score for determining a bristle strength with a score range for determining a bristle strength stored in the storage unit 14 and select a bristle strength corresponding to the calculated score for determining a bristle strength, and then store the selected bristle strength in the storage unit 14 (S16).

For example, the score range for determining the regular bristle may be 0 to 20, the score range for determining the mixed bristles may be 21 to 79, and the score range for determining the ultra-fine bristle may be 80 to 100.

In this way, when the operation of determining a bristle strength is completed, the operation control unit 12 may transmit the user's answer to each question for determining a bristle strength, the calculated score for determining a bristle strength, and the selected bristle strength as teeth-related information to the toothbrush type recommendation server 20 by using the communication unit 13 (S17).

Therefore, the server management unit 21 of the toothbrush type recommendation server 20 may store the user's answers transmitted from the user terminal 10, the score for determining a bristle strength, and the selected bristle strength in the customer information database 30 as teeth-related information of the corresponding customer (S18).

Next, the operation control unit 12 of the user terminal 10 may read the bristle shape determining questionnaire from the storage unit 14 through the output unit 15 and output the questionnaire through the output unit 15 (S19).

As already described above, a bristle shape may be categorized into a flat type and a centrifugal type.

There may be a total of three questions for determining a bristle shape in the toothbrush shape determining questionnaire.

For example, as shown in [Table 2], in the bristle shape determining questionnaire, there may be provided questions associated with at least one of the following: the occurrence of either or both tooth decay and periodontal disease, the occurrence of calculus and plaque, and the structure of the inner side of the anterior teeth.

Therefore, in this example, factors for selecting a bristle shape may be at least one of the following: dental impurities such as at least one of calculus and plaque (calculus/plaque), an abnormal dental condition such as at least one of tooth decay and periodontal disease, and the structure of the inner side of the anterior teeth.

Therefore, the operation control unit 12 may display the abnormal dental condition such as the occurrence or degree of at least one of tooth decay and periodontal disease through the output unit 15, and to this end, it may be asked whether there are no or few tooth decay/periodontal diseases in specific areas or whether there is frequent occurrence of tooth decay/periodontal diseases in specific parts.

In this example, the specific areas may include at least one area in the entire area inside the mouth, rather than a specially designated part inside the mouth.

Regarding the dental impurities, it may be asked whether calculus and plaque is excessively formed in a specific area or a degree of the calculus and plaque, and to this end, questions about whether there is no or few formation of calculus/plaque in the specific area or whether calculus/plaque is excessively formed in the specific area may be asked.

In addition, through the output unit 15, the operation control unit 12 may output a question regarding the structure of the inner side of the anterior teeth, such as whether the user is a person with the anterior teeth in an even structure and average or wide size or whether the user is a person with the anterior teeth in a complex structure and narrow size.

At least one question in the bristle shape determining questionnaire may be omitted or another question may be added.

Even in this case, scores are predetermined for answers to the three questions, so the operation control unit 12 may assign a score according to an answer input through the user input unit 11 and then calculate an integrated score for the three questions.

TABLE 2

| Ranking | Division | Score | flat type | centrifugal |
|---|---|---|---|---|
| 1 | tooth decay/periodontal | 50 | No or few tooth | tooth |
| | disease in a specific area | | decay/periodontal | decay/periodontal |
| | | | disease in a specific | disease frequently |
| | | | area | occurring in a |
| | | | | specific area |
| 2 | calculus/plaque formed in | 30 | n or few | calculus/plaque |
| | a specific area | | calculus/plaque | excessively formed |
| | | | formed in a specific | in a specific area |
| | | | area | |
| 3 | structure of the inner side | 20 | person with the | person with the |
| | of the anterior teeth | | anterior teeth of even | anterior teeth of |
| | | | structure and normal | complex structure |
| | | | or wide size | and narrow size |

| | |
|---|---|
| Total | 100 |

Tooth decay/periodontal disease in a specific area greatly affects the disease itself and the degree of dentin hypersensitivity depending on a bristle shape, so the highest score may be assigned. In addition, plaque and foreign substances may be effectively removed according to a bristle shape, so when a toothbrush having an appropriate bristle shape is used, plaque and foreign substances may be removed very effectively.

The accessibility of the toothbrush to the inner side of the anterior teeth is very crucial, so using bristles of an appropriate shape may be effective in removing plaque from the inner part of the anterior teeth.

Accordingly, the user may select an answer of choice for each question output through the output unit 15 using the user input unit 11.

When an answer to each question is input to the operation control unit 12 through the user input unit 11, the operation control unit 12 may, as described above, assign a predetermined score corresponding to the answer according to the input answer and store the assigned score in the storage unit 14 (S110).

When answers to all the questions in the bristle shape determining questionnaire are input from the user input unit 11, the operation control unit 12 may calculate and store a score for determining a bristle shape by summing up all the scores given according to the respective answer (S111).

Next, the operation control unit 12 compares the calculated score for determining a bristle shape with a score range for determining a bristle shape, the range which is associated with each bristle shape and stored in the storage unit 14, and select a bristle shape corresponding to the calculated score for determining a bristle shape, and store the selected bristle shape in the storage unit 14 (S112).

In this example, a flat bristle shape may be selected when the calculated score falls with the score range of 0 to 49, and a centrifugal bristle shape may be selected when the calculated score falls within the score range of 50 to 100.

Therefore, in [Table 2], when all answers input by the user are answers corresponding to a flat bristle shape, the selected bristle shape is a flat type, and when all answers input by the user are answers to a centrifugal bristle shape, the selected bristle shape may be a centrifugal type.

As such, when the operation of determining a bristle shape is completed (S112), the operation control unit 12 may transmit the user's answer to each question for determining a bristle shape, the calculated score for determining a bristle shape, and the selected bristle shape to the toothbrush type recommendation server 20 as teeth-related information by using the communication unit 13 (S113), and the server management unit 21 may store the transmitted information in the customer information database 30 as the teeth-related information of the customer (S114).

Therefore, due to the operation of the user terminal 10, the bristle shape may be selected according to the user's dental condition and oral condition.

Next, similarly to what has already been described, the operation control unit 12 may read a number-of-lines-of-bristles determining questionnaire, stored in the storage unit 14, from the storage unit 14 and outputs the questionnaire to the output unit 15 (S115), and then receive an answer to each question through the user input unit 11 (S116).

Similar to what has already been described, scores may be predetermined for answers to each question, and the operation control unit 12 may assign a scores corresponding to each answer input through the user input unit 11 and calculate a score for determining the number of lines of bristles by summing up the assigned scores (S117).

Then, the operation control unit 12 may compare the score for determining the number of lines of bristles with a score range for determining the number of lines of bristles, which is set for each predetermined number of lines of bristles, and select the number of lines of bristles corresponding to the calculated score for determining the number of lines of bristles (S118).

As shown in [Table 3], there are two questions for determining the number of bristle bristles provided in the number-of-lines-of-bristles determining questionnaire, and the questions may include a question about an oral structure and a question about whether there is an artificial tooth such as dental implant or denture. Therefore, factors for selecting the number of lines of bristles may be at least one of an oral structure and an artificial tooth.

For example, referring to [Table 3], the question about the oral structure may be a question about a structure and size, and for example, whether it is a narrow oral structure (i.e., V-shape), a normal oral structure (i.e., O-shape), or a wide oral structure (U shape). The question about whether there is an artificial tooth may be a question about whether there is a dental implant or denture, and for example, whether there is at least one of a dental implant and denture or whether there is no dental implant and denture.

The questions in the number-of-lines-of-bristles determining questionnaire are not limited thereto, and another question may be further provided.

TABLE 3

| Ranking | Division | Score | 4 lines | 5 lines | 6 lines |
|---|---|---|---|---|---|
| 1 | Oral | 70 | narrow oral | normal oral | wide oral |
| | structure | | structure | structure | structure |
| | and size | | [symbol] | [symbol] | [symbol] |
| 2 | Dental | 30 | dental implant | — | denture |
| | implant/ | | | | |
| | denture | | | | |

| | |
|---|---|
| Total | 100 |

Thus, the user may select one of a narrow oral structure, a normal oral structure, and a wide oral structure according to a question output through the output unit 15, and may select an answer as to whether there is at least one of a dental implant and denture.

Accordingly, 4 lines of bristles may be selected in the case of using a dental implant and having a narrow oral structure, 5 lines of brittles may be selected in the case of using no dental implant or denture and having a normal oral structure, and 6 lines of brittles may be selected in the case of using a denture and having a wide oral structure.

Since the oral structure and size affect the accessibility to teeth and the plaque removal, it may be advantageous to have a large number of lines of bristles in a toothbrush when the oral structure or size is large.

In the case of implants and dentures, there is a difference in material, but since tooth stain and plaque removal are important, a large number of lines of bristles may be advantageous.

As such, when the score for determining the number of lines of bristles is calculated and the operation of determining the number of lines of bristles is completed using the calculated score for determining the number of lines of bristles, the operation control unit 12 may transmit the user's answer, the calculated score for determining the number of lines of bristles, and the selected number of lines of bristles to the toothbrush type recommendation server 20 as teeth-related information (S119), and the server management unit 21 may store the transmitted teeth-related information in the customer information database 30 (S120).

Through the above operations, when the bristle strength, the bristle shape, and the number of lines of bristles are all selected for the user, the operation control unit 12 may select a toothbrush type corresponding to the selected information by using data stored in the storage unit 14 and output the selected toothbrush type to the output unit 15 to recommend a toothbrush of the selected type to the user (S121) and may also output an address of an online shopping mall where to purchase the toothbrush (S122).

At this point, the operation control unit 12 of the user terminal 10 may transmit the selected toothbrush type to the toothbrush type recommendation server 20, and the toothbrush type recommendation server 20 may store the selected toothbrush type in the customer information database 30.

Accordingly, the user may recognize a toothbrush type suitable for the user's current dental and oral condition by using the information output through the output unit 15, which is helpful when purchasing a toothbrush.

In addition, the user may conveniently purchase a toothbrush of the corresponding type using the provided address of the online shopping mall.

Therefore, when the address of the shopping web site provided through the user input unit 11 is selected and a toothbrush purchase signal is input (S122), the operation control unit 12 may access the corresponding online shopping mall through the communication unit 13 to enable a purchase of the toothbrush (S123).

In this example, as shown in FIG. 3a, 3G, and 5, the selection of a toothbrush type is conducted in the following order: the operation of determining a toothbrush bristle strength (S13-S18)-> the operation of determining a toothbrush bristle shape (S19-S114)-> the operation of determining the number of lines of bristles (S115-S120).

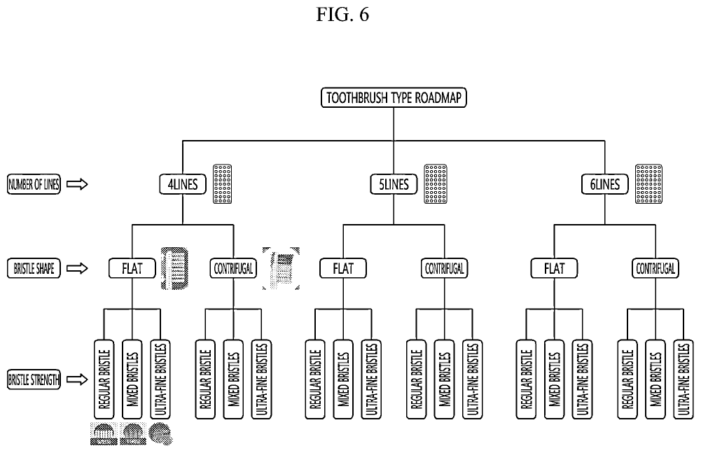

However, the present disclosure is not limited thereto, and the order of the operation of determining the bristle strength, the operation of determining a bristle shape, and the operation of determining the number of lines of bristles may be changed as needed. For example, as shown in FIG. 6, in the order of the operation of determining the number of lines of bristles, the operation of determining a toothbrush bristle shape, and the operation of determining a toothbrush bristle strength, the operation of determining the number of lines of bristles may be performed first and determining a bristle strength determination may be performed last.

Also, in an alternative example, some of the operations performed in the user terminal may be performed in the toothbrush type recommendation server 20. In this case, at a corresponding time, the user terminal 10 may sequentially receive and output a toothbrush strength determining questionnaire, a bristle shape determining questionnaire, and a number-of-lines-of-bristles determining questionnaire from the toothbrush type recommendation server 20, and may receive an answer to each question through the user input unit 11 and transmit the received answer to the toothbrush type recommendation server 20.

Therefore, at a corresponding time, the server management unit 21 of the toothbrush type recommendation server 20 may calculate a score for determining a bristle strength, a score for determining a bristle shape, and a score for determining the number of lines of bristles by using answers to questions transmitted from the user terminal 10, compare the calculated scores with data stored in the storage unit 23, and select a bristle strength, a bristle shape, and the number of lines of bristles respectively corresponding to the calculated scores, and finally determine a toothbrush type.

Next, the server management unit 21 of the toothbrush type recommendation server 20 may transmit the determined toothbrush type and the address of the online shopping mall to the user terminal 10, so that the operation control unit 12 outputs the transmitted toothbrush type to the output unit 15.

As such, in this alternative example, the user terminal 10 may serve to output data transmitted from the toothbrush type recommendation server 20 and transmit the user's selection input through the user input unit 11 to the toothbrush type recommendation server 20.

On the other hand, the toothbrush type recommendation server 20 may perform an operation of determining a toothbrush type using the user's answer transmitted through the user terminal 10, thereby finally performing an operation of determining a toothbrush type suitable for the user's answer.

In addition, in order to determine a bristle strength, a bristle shape, and the number of lines of bristles, the user terminal 10 or the toothbrush type recommendation server 20 of this example uses only answers to each questionnaire provided to the user terminal 10.

However, unlike this example, at least one of a photo and video of the user's teeth and oral condition may be provided to the operation control unit 12 or the server management unit 21, and in this case, the operation control unit 12 or the server management unit 21 may additionally determine the user's teeth and oral condition using the photo or video provided.

In this case, for example, the operation control unit 12 or the server management unit 21 may analyze the color of the provided photo or video to determine whether there is a teeth or oral disease and a type of the disease.

Therefore, since errors in answers written by non-expert users can be corrected using photos or videos, it is possible to more accurately check the user's teeth and oral conditions and thus recommend a toothbrush of a more accurate type to the user.

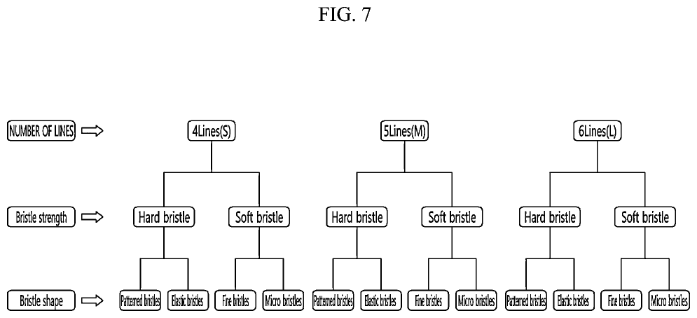

Next, referring to FIG. 7, the operation of the toothbrush type recommendation apparatus 1 according to another embodiment of the present disclosure will be described.

As already described above, in order to recommend a toothbrush type suitable for a user, toothbrush type determining questionnaires for determining a toothbrush type may be stored in the storage unit 14 of the user terminal 10.

As already described above, the toothbrush type determining questionnaires may include a number-of-lines-of-bristles determining questionnaire, a bristle strength determining questionnaire, and a bristle shape determining questionnaire.

Accordingly, even in this example, a toothbrush type suitable for a user may be recommended in consideration of the number of lines of bristles, the bristle strength, and the bristle shape.

In this example, the number of lines of bristles may be 4, 5, and 6, but as already described above, the types and number of lines of bristles may also be changed, for example, to 3, 4, and 5.

However, the bristle strength may be categorized into a regular bristle, mixed bristles and an ultra-fine bristle in FIGS. 5 and 6, while categorized into two types such as a soft bristle and a hard bristle in this example, as shown in FIG. 7.

In this example, for example, the soft bristle may correspond to a case where the bristle has a thickness equal to or less than a set value (e.g., 7 mils) and a circular cross section, while the hard bristle may correspond to case where the bristle has a thickness equal to or greater than the set value or a polygonal cross section.

In addition, the bristle shape may be categorized into a flat type and a centrifugal type in FIGS. 5 and 6, while categorized into four types, such as patterned bristles, elastic bristles, fine bristles and micro bristles in this example.

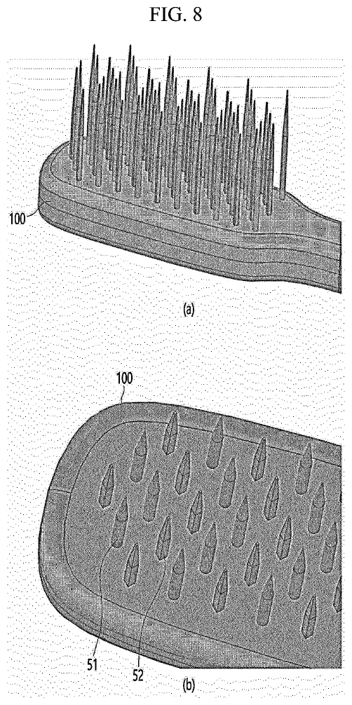

Referring to FIGS. 8 to 11, patterned bristles, elastic bristles, fine bristles, and micro bristles will be described.

FIGS. 8 to 11 are views to help understanding of each shape of bristles, and each drawing shows a structure in which one bristle is planted in one planting hole; however, this is merely for understanding each shape of bristle and a plurality of bristles of the same type or different types may be planted in a single planting hole.

First, referring to (a) and (b) of FIG. 8, the patterned bristles of this example will be described.

The patterned bristles according to this example may be arranged by alternately planting of bristles 51 and 52 of two different types along a longitudinal direction of a toothbrush head 100.

As shown in FIG. 8, the bristles 51 and 52 planted in the patterned bristles may include a first bristle 51 having a shape in which a cylinder and a cone are combined, and a second bristle 52 having a shape in which a polyhedron such as a square prism and a polygonal pyramid such as a quadrangular pyramid are combined.

The first bristles 51 and the second bristles 52 may be shaped through chemical etching.

As already described above, in the bristles planted in the same row of planting holes arranged along a longitudinal direction of the toothbrush head 100, the first bristle 51 and the second bristle 452 may be alternately planted.

A thickness of the first bristles 51 and a thickness of the second bristles 52 may have the same set value (e.g., 7 mils).

In addition, a height of the tip of the first bristle 51 and a height of the tip of the second bristle 52 may be different from each other, and the difference in height between the two tips may be 1.5 mm to 3 mm. For example, the height of the tip of the first bristle 51 may be about 12.5 mm, and the height of the tip of the second bristle 52 may be 9.5 mm to 11 mm. In this example, a height of a bristle may be a height from an inner surface of the toothbrush head 100 (that is, a surface in which the bristle is planted).

In the case of the patterned bristles, the cleaning power of the teeth surface may be improved due to the angular-shaped second bristle 52, and the removal of foreign substances such as plaque in an oral cavity may also be greatly improved despite the complex oral structure. In addition, the cleaning power may be further improved by the patterned bristles in which the bristles 51 and 52 of two different shapes are mixed.

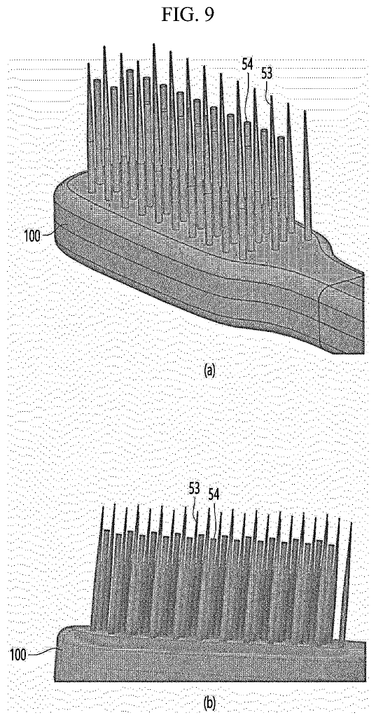

As shown in FIG. 9, the elastic bristle may include a third bristle 53 and a fourth bristle 54 of different shapes.

Each of the third bristle 53 and the fourth bristle 54 may have a cylindrical body, and a different shape of the tip thereof.

The third bristle 53 may have an elongated and conical shape by chemically etching the tip. Accordingly, the third bristle 53 may have a shape in which the cylinder and the cone are combined.

In the bristles having the same length, compared to the first bristles 51 planted in the patterned bristles, a conical portion in the third bristle 53 provided in the patterned bristles may occupy 30% or less of the patterned bristles, while a conical portion of the third bristle 53 provided in the elastic bristles may occupy 50% to 60% of the elastic brittles.

Therefore, since the proportion of the cone of the third bristle 53 in the bristles of the same length may be greater than the proportion of the cone of the first bristle 51, the third bristles 53 may have a shape thinner and sharper than that of the first bristle 51.

In the fourth bristle 54, both the body and the tip may have a cylindrical shape, so the fourth bristle 54 may have a cylindrical shape. In this example, the tip of the fourth bristle 54 is a flat surface, but may have a convex or concave tip like a curved surface.

Therefore, a diameter of the third bristle 53 decreases toward the tip, but the fourth bristle 54 may have the same diameter regardless of a position.

Accordingly, cross-sectional shapes of the third bristle 53 and the fourth bristle 54 may both be circular, and the thickness of each of the third bristle 53 and the fourth bristle 54 may be 8 mils.

In addition, a height of the tip of the third bristle 53 and a height of the tip of the fourth bristle 54 may be different from each other, and the height of the tip of the third bristle 53 may be higher than the height of the tip of the fourth bristle 54.

For example, the height of the tip of the third bristle 53 may be about 12 mm, the height of the tip of the fourth bristle 54 may be 8.5 mm to 9.5 mm, and the difference in height of the tip between the two bristles 53 and 54 may be 2.5 mm to 3.5 mm.

In the case of such elastic bristles, the cleaning power in a space between the teeth and gums may be improved due to the third bristle 53 having a pointed end, and the cleaning power on a teeth surface may be improved due to the fourth bristle 54 having a curved or flat surface. In addition, a thorough and refreshing cleaning of the surface may be performed and soft management of the gum line may be achieved.

Therefore, for the elastic bristles, it may be easy to remove bad breath, plaque, and calculus.

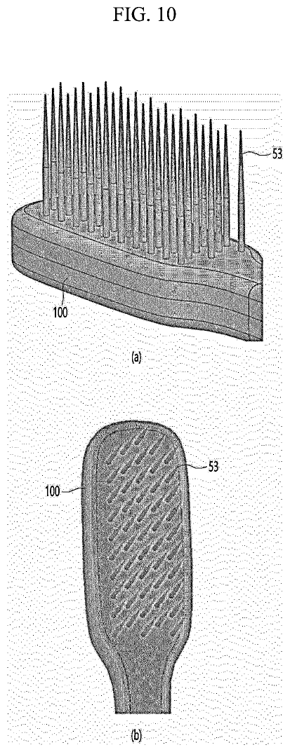

As shown in FIG. 10, the fine bristles may include the third bristle 53 in which a portion (e.g., a tip) of the bristle is chemically etched to refine the tip into a conical shape.

At this point, a thickness of the third bristle 53 planted in the fine bristles may be 7 mils, and a height of the tip of the third bristle 53 provided in the fine bristles may be 10 mm to 11 mm, which is slightly lower than the third bristle 53 of the patterned bristle.

As such, the fine bristles provided as the third bristles 53 having a long and thin tip may improve the cleaning power between the teeth and gums and reduce irritation due to the long and thin tip of the conical part.

In addition, compared to a round or flat bristle, the tip of the bristle is conical, narrow, pointed, and thin, so the bristle may reach the gum pockets without causing significant irritation, making it easier to remove impurities such as food debris or plaque and enabling gentle brushing for sensitive and delicate gums.

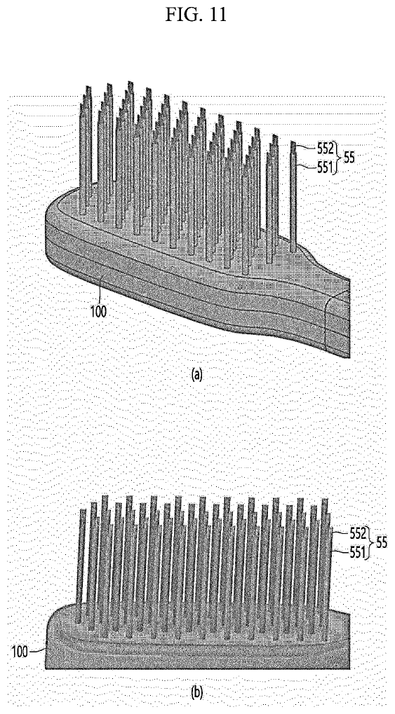

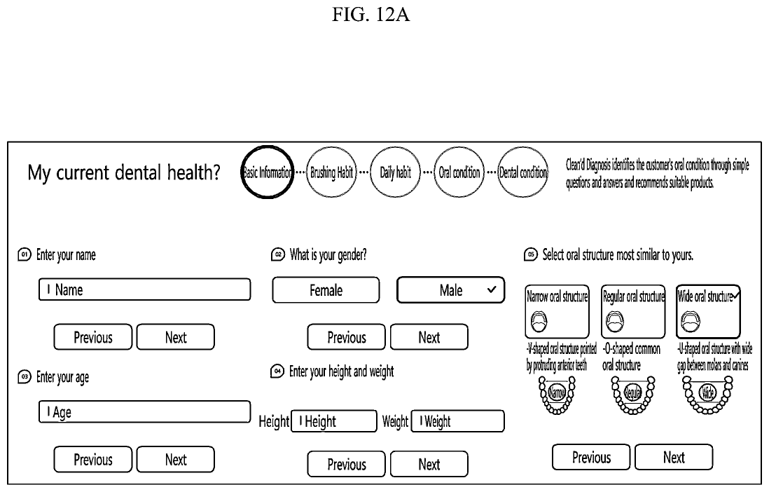

As shown in FIG. 11, the micro bristles may include a fifth bristle 55 having a shape in which a tip of a cylindrical bristle branch into multiple pieces (e.g., 4). Accordingly, one fifth bristle 55 may have different strengths depending on a position. For example, the fifth bristle 55 may be divided into a cylindrical body 551 having a first strength and a tip 552 having a second strength much weaker than the body portion 551 and divided into a plurality of pieces. Accordingly, one micro bristle may have a plurality of tips 553 spaced apart from each other in one body 551.

In this example, a thickness of the fifth bristles 55, for example, a thickness of the body 551, may be 7 mils.

In addition, a height of the tip of the fifth bristle 55, that is, a height of the end of the tip 552 may be 10 mm to 11 mm.

Due to this structure, the micro bristles has significantly lower strength at a point in contact with a surface subject to cleaning, such as teeth, compared to the body, resulting in increased softness and enabling high-density care.

In addition, due to the tip of the fifth bristle 55 branched into a plurality of pieces, the fifth bristle 55 may generate abundant foam even with a small amount of toothpaste, resulting in increased cleaning power, and this reduces the stimulation on teeth and gums, making it safe for adults and infants with sensitive gums and teeth to use the toothbrush.

In addition, due to the branched tip, the fifth bristle 55 may more efficiently deliver the toothpaste to a target area during a test using a Drug Delivery System (DDS), so that the accuracy of the test can be increased.

Therefore, for example, the patterned bristles and the elastic bristles may be classified as hard bristle, and the fine bristles and the micro bristles may be classified as soft bristle.

Next, with reference to FIG. 7, an operation of recommending a toothbrush type according to this example having such bristle shapes will be described in detail.

As already described above, in FIG. 6, the sequence of the operations may be the operation of determining the number of lines of bristles-> the operation of determining a bristle shape-> the operation of determining a bristle strength, but the operation of recommending a toothbrush type according to this example shown in FIG. 7 may be performed in the order of the operation of determining the number of lines of bristles-> the operation of determining a bristle strength-> the operation of determining a bristle shape.

Except for the difference in the order of the determining operations, the operation of recommending a toothbrush type according to this example may be the same as described with reference to FIGS. 5 and 6.

Therefore, in the same manner as steps S11 and S12 of FIG. 3A, the operation control unit 11 of the user terminal 10 may output an initial screen and, upon determining that a start button for toothbrush type recommendation is activated based on a signal input through the user input unit 11, start recommending a toothbrush type.

Therefore, the operation control unit 12 may read the number-of-lines-of-bristles determining questionnaire from among the toothbrush type determining questionnaires stored in the storage unit 14 and output the questionnaire to the output unit 15.

As shown in [Table 4], the number-of-lines-of-bristles determining questionnaire may include questions for selecting an oral structure, age, gender, height, and weight, and one of a V-shaped narrow oral structure, an O-shaped ordinary oral structure, and a U-shaped wide oral structure may be selected as the oral structure.

For example, the age may be divided into set age groups such as 13 years old and below, 14-18 years old, 19-50 years old, and 51 years old and above, and one of them can be selected.

For gender, either male or female may be selected.

In addition, for height, one of 160 cm or less, 161 to 179 cm, and 180 cm or higher may be selected.

the For example, for the weight, one of 60 kg or less, 61 to 79 kg, and 80 kg or more may be selected.

TABLE 4

| Division | Factor | Option | Value |
|---|---|---|---|
| Oral structure | Oral structure | V shape | 15 |
| | | O shape | 20 |
| | | U shape | 30 |
| Age | Age | 13 and below | 10 |
| | | 14 to18 | 10 |
| | | 19 to 50 | 25 |
| | | 51 and above | 25 |
| Gender | Gender | Male | 15 |
| | | Female | 7 |
| Height | Height | 160 cm or less | 5 |
| | | 161 to 179 cm | 10 |
| | | 180 or more | 20 |
| Weight | Weight | 60 kg or less | 5 |
| | | 61 to 79 kg | 10 |
| | | 80 kg or more | 15 |

As shown in [Table 4], values are determined according to the selectable options for each question, so the operation control unit 12 may calculate a score (x) for determining the number of lines of bristles by summing scores according to the user's selected options, compare a predetermined score range for determining the number of lines of bristles with the calculated score x, finally select the number of lines of bristles (e.g., 4 lines, 5 lines, or 6 lines) corresponding to the calculated score x, and store the selected number of lines of bristles in the storage unit 14.

In one example, the score range for determining the number of lines of bristles may be divided into 1 to 65, 66 to 85, and 86 to 100, and the selected number of lines of bristles is 4 lines if the score x for determining the number of lines of bristles is between 1 and 65, the selected number of lines of bristles is 5 lines if the score x for determining the number of lines of bristles is between 66 and 85, and the selected number of lines of bristles is 6 lines if the score x for determining the number of lines of bristles is between 86 and 100.

As such, when the number-of-lines-of-bristles determining questionnaire with options is output to the output unit 15, a user may select an answer for each option using the user input unit 11.

When selecting of answers to the number-of-lines-of-bristles determining questionnaire is completed and an answer completion signal is input to the user input unit 11, the operation control unit 12 may store the answers input to the questionnaire in the storage unit 14 and calculate a score for determining the number of lines of bristles by summing up scores assigned to respective selected options.

Next, the operation control unit 12 may compare the calculated score for determining the number of lines of bristles with a score range for determining the number of lines of bristles stored in the storage unit 14, determine the number of lines of bristles corresponding to the calculated score, and store the determined number of lines of bristles in the storage unit 14.

As such, when the operation of determining the number of lines of bristles is completed, the operation control unit 12 may transmit the user's answers to each question for determining the number of lines of bristles, the calculated score for determining the number of lines of bristles, and the selected number of lines of bristles as teeth-related information to the toothbrush type recommendation server 20 using the communication unit 13.

In addition, the operation control unit 12 may read the bristle strength determining questionnaire stored in the storage unit 14 and output the questionnaire to the output unit 15 to perform an operation of selecting a bristle strength.

In order to determine a bristle strength, the bristle strength determining questionnaire may include selectable options for determining smoking, a calculus and plague condition, age, a dentin hypersensitivity condition, a gum inflammation condition, and frequency of brushing, as shown in [Table 5].

At least one factor of calculus or plaque may include an average brushing time, crooked teeth, and teeth scaling within one year. Therefore, an option to be selected using the user terminal 10 in order to determine the presence or absence of at least one of calculus and plaque may be at least one of an average tooth brushing time, whether there is a crooked teeth, and whether teeth scaling has been performed within one year.

Since the average brushing time may be categorized into, for example, about 1 minute, about 2 minutes, and about 3 minutes or more, and a user may select one of them using the user terminal 10.

The age of the user may be categorized into, for example, 13 or younger, 14 to 18, 19 to 50, and 51 or older, and the user's age may be selected therefrom.

Factors for dentin hypersensitivity may be sensitive tooth and drinking carbonated beverages, so the option for determining the presence of dentin hypersensitivity may be the presence of dentin hypersensitivity and drinking carbonated beverages.

Factors for gum inflammation may be bleeding gums, a loose tooth, and swelling or pain in the gums. Accordingly, options for determining whether there is gum inflammation may include whether there is bleeding from the gums, whether there is a loose tooth, and whether there is swollen gums.

The frequency of brushing may be the number of times of brushing teeth per day, and for example, the number of times of teeth brushing per day may be categorized into 1 time, 2 times, and 3 or more times, and a user may select one of them using the user terminal 10.

As shown in [Table 5], a value is determined for each selectable option. In [Table 5], Y/N indicates a case where a fixed value is given when a corresponding option is selected, and N/Y indicates a case where a fixed value is given when a corresponding option is not selected.

For example, for the crooked tooth, it is of Y/N option, so if the crooked tooth is selected, a score of 12 may be given, and if the crooked tooth is not selected, a score of 0 may be given, and for the sensitive tooth, it is of N/Y option, so if the sensitive tooth is selected, a score of 0 instead of 8 may be given, and if the sensitive tooth is not selected, a score of 8 may be given.

When the bristle strength determining questionnaire with the aforementioned options is output to the output unit 15, a user may select an answer for each option using the user input unit 11 and completes answering the options.

Therefore, when an answer completion signal is input from the user input unit 11, the operation control unit 12 may store the answers input to the bristle strength determining questionnaire in the storage unit 14, and then calculate a score y for determining a bristle strength by summing all scores assigned to respective selected options.

Next, by comparing the calculated score y for determining a bristle strength with a score range for determining a bristle strength stored in the storage unit 14, a bristle strength corresponding to the calculated score y for determining a bristle strength may be determined and the selected bristle strength may be stored in storage unit 14.

In addition, the operation control unit 12 may transmit the user's answer to each question for determining a bristle strength, the calculated score for determining a bristle strength, and the selected bristle strength as teeth-related information to the toothbrush type recommendation server 20 the communication unit 13,

The selectable bristle strength may be one of soft bristle and hard bristle, and for example, if a score y for determining a bristle strength is equal to or less than a set value (e.g., a score of 57), a soft bristle may be selected, ad If the score y exceeds the set value, a hard bristle may be selected.

Therefore, when the score y for determining a bristle strength is between 1 and 57, the selected bristle strength may be soft bristle, and when the score y for determining a bristle strength is between 58 and 100, the selected bristle strength may be hard bristle.

TABLE 5

| Division | Factor | Option | Value |
|---|---|---|---|
| Smoking | Smoking | Y/N | 12 |
| calculus/plaque | average brushing | about 1 minute | 15 |
| | time | about 2 minutes | 12 |
| | | 3 minutes or more | 6 |
| | crooked tooth | Y/N | 12 |
| | teeth scaling within | N/Y | 10 |
| | one year | | |
| Age | Age | 13 and below | 5 |
| | | 14 to18 | 10 |
| | | 19 to 50 | 10 |
| | | 51 and above | 5 |
| dentin | sensitive tooth | N/Y | 8 |
| hypersensitivity | drinking carbonated | N/Y | 8 |
| | beverage | | |
| gum inflammation | bleeding gums | N/Y | 5 |
| | loose tooth | N/Y | 5 |
| | swollen gums | N/Y | 5 |
| number of times of | number of times of | 1 time | 10 |
| brushings per day | brushings per day | 2 times | 2 |
| | | 3 times or more | 0 |

As such, when the operation of determining a bristle strength suitable for the user is completed using the bristle strength determining questionnaire, the operation control unit 12 may perform an operation for determining a bristle shape.

Therefore, when bristle strength determined through the bristle strength determining questionnaire is hard bristle, the operation control unit 12 may read the bristle shape determining questionnaire stored in the storage unit 14 and output the questionnaire to the output unit 15.

In order to determine the bristle shape, the bristle shape determining questionnaire may include questions for determining a bristle shape including at least one of the following: whether there crooked teeth, whether there is a wisdom tooth, whether teeth scaling has been performed within one year, whether there is a loose tooth, whether there is bleeding gums, whether there is swollen gums, and whether the user's age satisfies a set age (e.g., 50 years or above).

In this example, the bristle shapes selectable according to answers of each question in the bristle shape determining questionnaire may be one of patterned bristles and elastic bristles in response to the selected bristle strength being hard or may be one of fine bristles and micro bristles in response to the selected bristle strength being soft.

Therefore, for example, in a state in which the strength of the bristle is selected as hard bristle, if there are at least two of the following conditions: a wisdom tooth, crooked teeth, and no teeth scaling within one year, an elastic bristles may be selected as the bristle shape, and if not, the patterned bristles may be selected by default.

On the other hand, in a state where the strength of the bristle is selected as soft bristle, if there is at least one of the following: a sensitive tooth, a loose tooth, bleeding gums, swollen gums, and the user's age above a set age (e.g., 50 years old or older), the micro bristle may be selected as the bristle shape, and if not, the fine bristle may be selected by default.

Accordingly the operation control unit 12 may determine a bristle shape according to answers of the bristle shape determining questionnaire and store the selected bristle shape in the storage unit 14.

The operation control unit 12 may transmit the user's answer to each question for determining a bristle shape and the selected bristle shape to the toothbrush type recommendation server 20 as teeth-related information.

As such, when the bristle strength is soft, the user may select softer fine bristles or micro bristles according to the user's preference, so this widens the range of the user's choices, leading to increased satisfaction.

According to this example, compared to the case of FIGS. 5 and 6, the number of selectable toothbrush types is reduced and the user's selecting process is performed simpler, thereby further improving the user's convenience.

Next, with reference to FIG. 4, customer management performed in the toothbrush type recommendation server 20 will be described.

The server management unit 21 of the toothbrush type recommendation server 20 may receive a user's answers to questions, information on a selected number of lines of bristles, a selected toothbrush strength, and a selected toothbrush shape, and each calculated score from the user terminal 10 through the communication unit 22, and calculate a toothbrush usage period using a selected toothbrush type and the customer's question answers (S21).

For example, by utilizing calculation methods or artificial intelligence (AI) technology stored in the storage unit 23, the server management unit 21 may determine a period of usage of the selected toothbrush type based on the number of lines of bristles in the selected toothbrush type, the selected bristle strength, the selected bristle shape, the customer's frequency of brushing, oral structure and size, and the presence of a dental implant or denture and may store the determined period of usage in the storage unit 14.

Next, by using a timer, the server management unit 21 may calculate a toothbrush replacement date to calculate a time elapsed since the toothbrush usage period is determined (S22). At this point, the timer may be located inside or outside the server management unit 21.

Then, the server management unit 21 may determine whether there are specified days remaining from the current date to the toothbrush replacement date or whether the current date is a toothbrush replacement notification date (S23). In this case, the specified days may be the number of days remaining until the toothbrush replacement date, and the specified days may be 7 days. Thus, when the toothbrush replacement date is March 20, the toothbrush replacement notification date may be March 13.

When the present time has reached and corresponds to the toothbrush replacement notification date (S23), the server management unit 21 may use contact information stored in the customer information database 30 to transmit a toothbrush replacement timing notification message to the user terminal 10 through a messenger servers or the like (S24). A toothbrush replacement timing guidance message may be transmitted.

At this point, the server management unit may transmit an address of a toothbrush online shopping mall together with the toothbrush replacement timing notification message, and in this case, the customer may quickly and easily purchase the corresponding toothbrush type using the user terminal 10.

However, in step S23, if the current date has not reached the toothbrush replacement notification date, the server management unit 21 may predict at least one tooth and oral disease that is highly likely to occur based on the customer's answer to each question (S25). To this end, the server management unit 21 may use a disease predicting method stored in the storage unit 23 or use an artificial intelligence technology.

Next, the server management unit 21 may transmit the predicted tooth and oral disease and information on the predicted disease to the user terminal 10 based on the contact information stored in the customer information database 30 (S26).

Accordingly, the operation control unit 12 of the user terminal 10 may output the predicted tooth and oral disease and the information on the same transmitted from the toothbrush type recommendation server 20.

Therefore, based on the information output to the output unit 15 of the user terminal 20, the user may be able to accurately determine the current teeth and oral condition and receive an appropriate treatment, thereby maintaining dental and dental health and preventing progression into a more serious disease.

In the above example, the number-of-lines-of-bristles determining questionnaire, the bristle strength determining questionnaire, and the bristle shape determining questionnaire may be output to the output unit 15 at respective steps under the control of the operation control unit 12, so that the user can select answers.

However, in an alternative example, the number-of-lines-of-bristles determining questionnaire, the bristle strength determining questionnaire, and the bristle shape determining questionnaire are not separately provided, but questions for determining the number of lines of bristles, questions for determining a bristle strength, and questions for determining a bristle shape are integrated into one integrated questionnaire and the integrated questionnaire may output the questions sequentially through the output unit 15, so that the user can select answers.

At this point, at least one among the questions for determining the number of lines of bristles (e.g., questions for determining the number of lines of bristles), the questions for determining a bristle strength (e.g., questions for determining a bristle strength), and questions for determining the shape of bristles (e.g., questions for determining a bristle shape) may be redundant, but there may be only one item for the same question in the integrated questionnaire.

Since the operation control unit 12 is already aware of the questions for determining the number of lines of bristles, the questions for determining a bristle strength, and the questions for determining a bristle shape through the contents stored in the storage unit 14, it is possible to normally determine the number of lines of bristles, the bristle strength, and the bristle shape by referring to the questions and answers of the integrated questionnaire.

That is, based on information of the storage unit 14, the operation control unit 12 is already aware of which determination each question in the integrated questionnaire corresponds from among determining the number of line of bristles, determining bristle strength, or determining a bristle shape, so an operation for determining the number of lines of bristles, a bristle strength, or a bristle shape may be performed depending on a question.

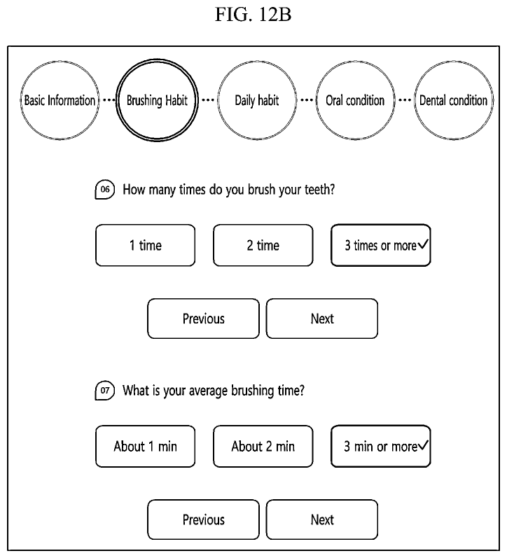

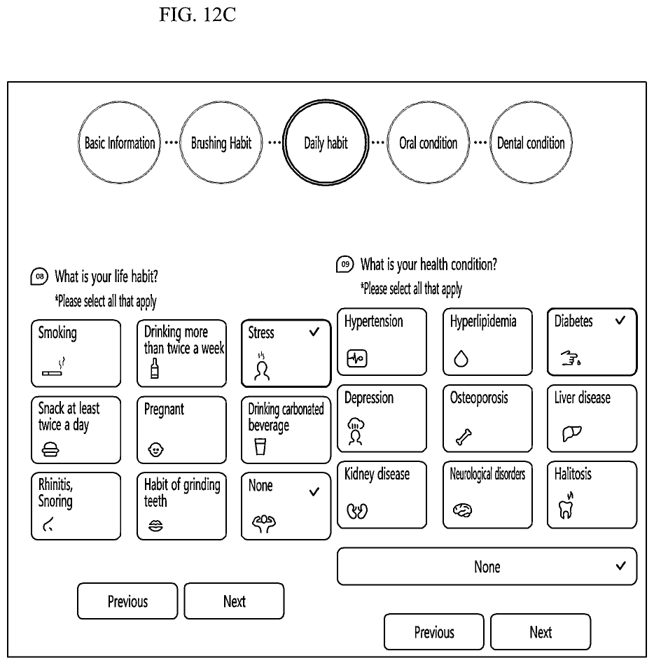

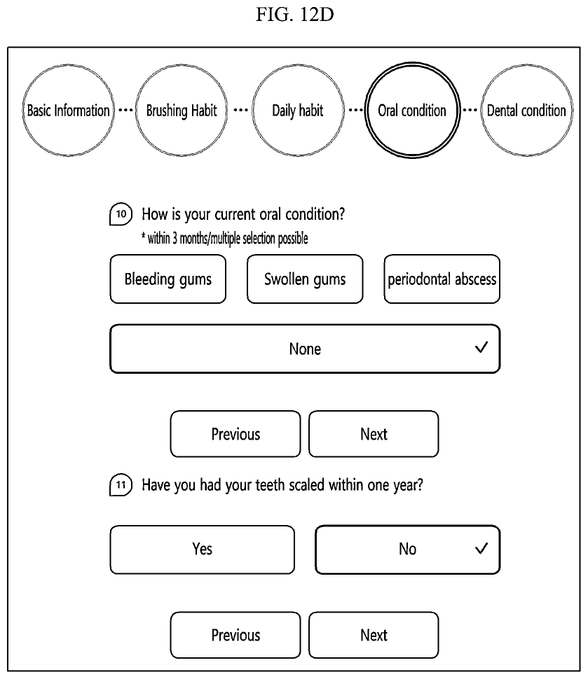

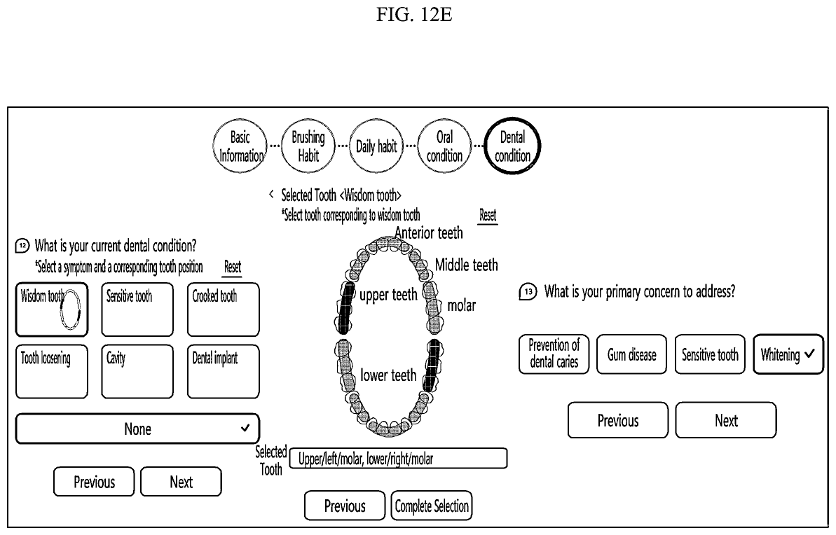

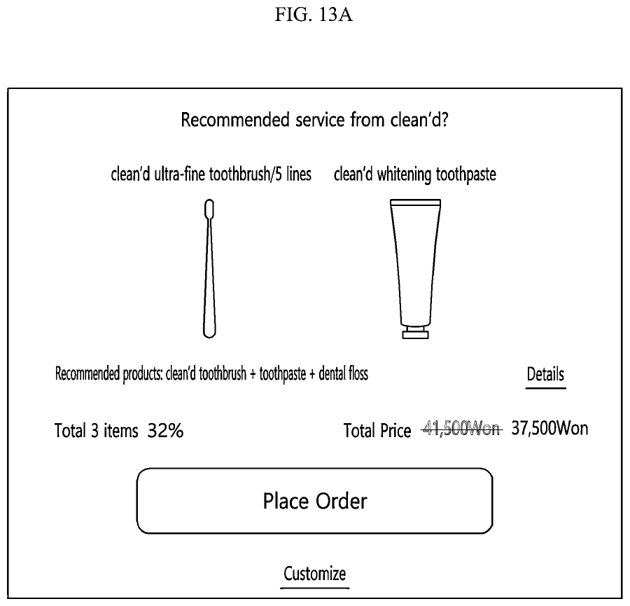

Examples of the integrated questionnaire output to the output unit 15 are shown in FIGS. 12A and 12B.

Accordingly, by using the user input unit 11, the user may select an option representing his or her conditions and answer questions about the user's basic information, brushing habit, daily habit, oral condition, and dental condition.

As shown in FIG. 12A, the questions about basic information may include name, gender, age, height and weight, and oral structure. Images and descriptions of oral structures in the basic information may be output to the output unit 15, so that the user can accurately determine the user's oral structure and gives an accurate answer.

Therefore, the user may refer to the images and descriptions of a narrow oral structure (i.e., V-shaped structure), a normal oral structure (i.e., O-shaped structure), and a wide oral structure (i.e., U-shaped structure) output to the output unit 15, and then make an accurate selection of the user's oral structure.

As shown in FIGS. 12B and 12C, the questions about brushing habits may include questions about a frequency of brushing and an average brushing time, and the questions about daily habits may include questions about daily habit, health, and conditions.

In addition, as shown in FIGS. 12D and 12E, the questions about the oral condition may include questions about the oral condition and whether teeth scaling has performed within one year, and the questions about the dental condition may include a question about the current state of the teeth and the primary concerns to address.

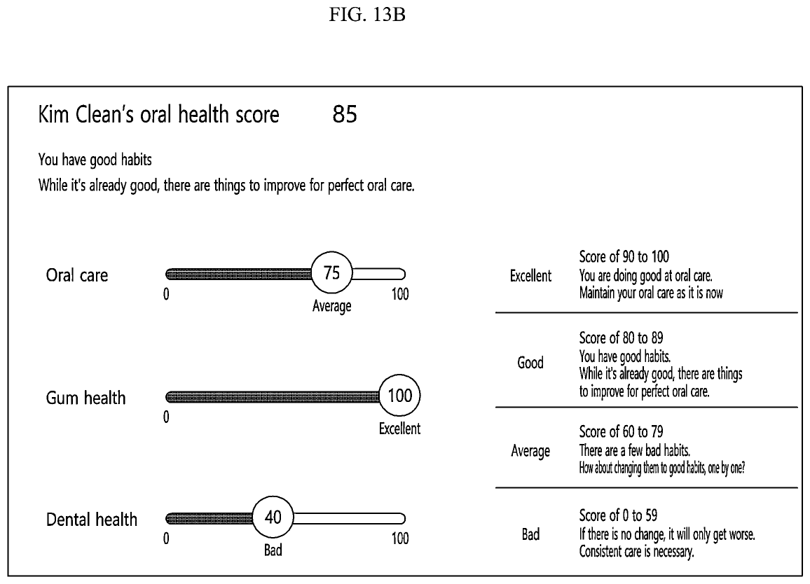

As such, when answers to questions output from the output unit 15 are made through the user input unit 11, the operation control unit 12 may sequentially select the number of lines of bristles and the bristle strength by calculating a score according to an answer through the above-described operation, select a bristle shape according to the selected bristle strength, and then output a result to the output unit 15 as shown in FIGS. 13A and 13B.

In addition, in an alternative example, in addition to the determined number of lines of bristles and the bristle shape, the operation control unit 12 may convert an oral hygiene condition, gum health, and dental health into scores (e.g., an oral care score, a gum health score, and a dental health score) based on answers input from the user input unit 11, and may further output an integrated score calculated using the oral hygiene score, the gum health score, and the dental health score.

Among result values output to the output unit 15, a toothpaste suitable for the user may be recommended in FIG. 13A, and in this case, the operation control unit 12 may recommend a type of toothpaste based on the user's answer to the question about the primary concerns to address among the questions about the dental condition shown in FIG. 12E. For example, based on data of the storage unit 14, the operation control unit 12 may recommend a toothpaste having the whitening effect if the answer to the question about the concerns to solve is “whitening”, and may recommend a toothpaste effective in sensitive teeth if the answer is “sensitive tooth”.

In addition, the operation control unit 12 may present a toothbrush type suitable for the user and necessary dental products (e.g., toothpaste and dental floss) as well as prices thereof. Information on the prices may also be prestored in the storage unit 14.

As shown in [Table 6], factors for determining an oral care condition may be the number of brushing per day, an average brushing time, teeth scaling within one year, drinking carbonated beverages, smoking, bad breath, having snack twice a day or more, and grinding teeth.

TABLE 6

| Factor | Option | Value | Reference |
|---|---|---|---|
| number of times of | 1 time | 0 | Y/N |
| brushings per day | 2 times | 15 | Y/N |
| | 3 times or more | 20 | Y/N |
| average brushing | about 1 minute | 0 | Y/N |
| time | about 2 minutes | 20 | Y/N |
| | 3 minutes or more | 25 | Y/N |
| teeth scaling within | — | 20 | Y/N |
| one | | | |
| drinking carbonated | — | 10 | N/Y |
| beverage | | | |
| Smoking | — | 10 | N/Y |
| bad breath | — | 5 | N/Y |
| having snack at least | — | 5 | N/Y |
| 2 times a day | | | |
| habit of grinding | — | 5 | N/Y |
| teeth | | | |

Therefore, as shown in [Table 6], any one score of 0, 15, and 20 may be selected according to the number of brushing per day, and any one score of 0, 20, and 25 points may be selected according to the average brushing time.

In addition, if teeth scaling has been performed within one year, the score of 20 may be selected, or otherwise, the score of 0 may be selected, and each of drinking carbonated beverages and smoking is of N/Y, so if it is the case, the score of 0 may be selected, and if not, the score of 10 may be selected.

Each of having bad breath, having snacks twice or more a day, and grinding teeth is of N/Y, so if it is the case, the score of 0 may be selected, and if not, the score of 5 may be selected.

As shown in Table 7 below, factors for determining gum health may include oral care, a loose tooth, bleeding gums, swollen gums, periodontal abscess, and age.

TABLE 7

| Factor | Option | Value | Reference |
|---|---|---|---|
| oral care | — | 25% | |
| a loose tooth | — | 20 | N/Y |
| bleeding gums | — | 20 | N/Y |
| swollen gums | — | 15 | N/Y |
| periodontal abscess | — | 10 | N/Y |
| Age | 13 and below | 10 | Y/N |
| | 14 to18 | 10 | Y/N |
| | 19 to 50 | 10 | Y/N |
| | 51 and above | 0 | Y/N |

Since the gum health is greatly influenced by oral care, the oral care score may be provided as a factor for determining gum health, as shown in [Table 7]. Therefore, the oral care factor in [Table 7] represent the weight given to the oral care score calculated based on answers to the questions listed in [Table 6], and a score corresponding to 25% of the calculated oral care score may be inserted as a factor for determining a gum health condition.

In addition, as shown in [Table 7], when any of a loose tooth, bleeding gums, swollen gums, and periodontal abscess exists, a score of 0 may be given, and when a loose tooth, bleeding gums, swollen gums, and periodontal abscess do not exist, scores of 20, 20, 15, and may be selected respectively.

In addition, a score 10 or 0 may be selected depending on age: for example, a score of may be given for the age of 13 or below, a score of 10 for the age of 14 to 18, a score of 10 for the age of 19 to 50, and a score of 0 for the age of 51 or above.

As shown in [Table 8], the factors for determining a dental health condition may be oral care, a sensitive tooth, age, a loose tooth, a wisdom tooth, grinding teeth, drinking carbonated beverage, tooth decay, and a dental implant.

TABLE 8

| Factor | Option | Value | Reference |
|---|---|---|---|
| Oral care | — | 30% | Y/N |
| Sensitive tooth | — | 20 | N/Y |
| Age | 13 and below | 10 | Y/N |
| | 14 to18 | 10 | Y/N |
| | 19 to 50 | 10 | Y/N |
| | 51 and above | 0 | Y/N |
| Loose tooth | — | 10 | N/Y |
| Wisdom tooth | — | 5 | N/Y |
| Crooked tooth | — | 5 | N/Y |
| Drinking carbonated | — | 5 | N/Y |
| beverages | | | |
| Dental decay | — | 15 | N/Y |
| dental implant | — | 5 | N/Y |

Dental health is also heavily influenced by oral care and more affected compared to gum health. Therefore, as shown in [Table 8], an oral care score may be provided as a factor for determining dental health, and a score corresponding to 30% of the calculated oral care score may be inserted as a factor for determining dental health.

In addition, as shown in [Table 8], if sensitive tooth is present, a score of 0 may be selected and, if not, a score of 15 may be selected, and a score of 5, 10, or 0 may be selected depending on the age.

In [Table 8], a score of 0 may be selected when there is any of a loose tooth, a wisdom tooth, and teeth scaling, but scores of 10, 5, and 5 may be selected respectively when there is no loose tooth, a wisdom tooth, or teeth scaling.

A score of 0 may be selected in the case of drinking carbonated beverage, but a score of 5 may be selected otherwise.

Lastly, the score of 0 may be selected when there is dental decay and a dental implant, but the scores of 15 and 5 may be selected respectively for absence of dental decay and absence of dental implant.

As such, referring to the answers to the questionnaire, the operation control unit 12 may calculate respective integrated scores for the oral care condition, the gum health condition, and the dental health condition, and store the integrated scores as an oral hygiene score, a gum health score, and a tooth health score, respectively.

Next, the operation control unit 12 may calculate an integrated score obtained by converting the oral cavity condition of the user into a score using the calculated oral care score, gum health score, and dental health score.

The integrated score can be calculated as (oral care score×0.4)+(gum health score×0.3)+(dental health score×0.3).

In this way, when the integrated score is calculated, the operation control unit 12 may determine the oral cavity condition as bad, normal, good, or excellent according to the score and output the result to the output unit 15.

For example, the integrated score of 0 and 59 may indicate a poor oral cavity condition, the integrated score of 60 and 79 may indicate a normal oral cavity condition, the integrated score of 80 and 89 may indicate a good oral cavity condition, and the integrated score of 90 and 100 may indicate an excellent oral cavity condition.

In this example, it is possible to check the oral care condition, gum health state, and dental health state as points, as well as selection of toothbrush type according to the number of lines of bristles, bristle strength, and bristle shape, and the oral cavity condition using these scores.

Therefore, since the user can check the current oral cavity condition, the user can improve his or her daily habit according to the current state of the oral cavity. Although the embodiments of the present disclosure have been described in detail above, the scope of the present disclosure is not limited thereto, and various modifications and improvements by those skilled in the art using the basic concept of the present disclosure defined in the following claims are also included in the scope of the present disclosure.

1. A toothbrush type recommendation apparatus comprising: a user input unit, an output unit, and an operation control unit connected to the user input unit and the output unit and configured to: output questionnaires having a question for determining a number of lines of bristles, a question for determining a strength of the bristles, and a question for determining a bristle shape to the output unit; receive answers to the questionnaires from the user input unit to calculate a score for determining the number of lines of bristles and a score for determining a strength of the bristles; determine the number of lines of bristle and the bristle strength, which respectively corresponds to the calculated scores; with respect to the determined bristle strength, determine a final shape of bristles based on the answer to the questions for determining the shape of bristles in the questionnaires; select the determined final shape as a toothbrush type; and output the selected toothbrush type to the output unit.

2. The toothbrush type recommendation apparatus of claim 1, wherein the number-of-lines-of-bristles determining questionnaire comprises a question for determining the number of lines of bristles, the question associated with at least one of the following: an oral structure, age, gender, a height, and a weight, wherein the bristle strength determining questionnaire comprises a questions for determining a bristle strength, the question associated with the following: whether or not the user's age meets a condition of the set age, smoking, presence of at least one of calculus and plaque, bad breath, presence of abrasion in at least one of a cervical area and an apical area, presence of at least one of periodontal disease and dentin hypersensitivity, a number of brushing per day, an average brushing time, and whether there is an artificial tooth, and wherein the bristle shape determining questionnaire comprises a question for determining a bristle shape, the question associated with at least one of the following: presence of a crooked teeth, presence of a wisdom tooth, teeth scaling within one year, a loose tooth, bleeding gums, swollen gums, and whether the user's age meets a set age condition.

3. The toothbrush type recommendation apparatus of claim 2, wherein the operation control unit calculates a score for determining the number of lines of bristles and a score for determining the bristle strength by summing up scores corresponding to respective answers to the question for determining the number of lines of bristles and the question for determining a bristle strength.

4. The toothbrush type recommendation apparatus of claim 1, wherein the operation control unit calculates a score for determining the number of lines of bristles and determines the number of lines of bristles corresponding to the calculated score for determining the number of lines of bristles,
calculates a score for determining a bristle strength and determines a bristle strength corresponding to the calculated score for determining a bristle strength, to determine the bristle strength having the determined number of lines of bristles, and
determines the toothbrush type by selecting the bristle shape classified by the determined bristle strength, based on answers to a questionnaire for determining a bristle shape.

5. The toothbrush type recommendation apparatus of claim 1, wherein the operation control unit determines the number of lines of bristles as a first number of lines when the score for determining the number of lines of bristles is equal to or less than a first set value, determines the number of lines of bristles as a third number of lines greater than the first number of lines when the score for determining the number of lines of bristles is equal to or greater than a second set value greater than the first set value, and determines the number of lines of bristles as a second number of lines greater than the first number of lines and less than the third number of lines when the score for determining the number of lines of bristles is greater than the first set value and less than the second set value.

6. The toothbrush type recommendation apparatus of claim 1, wherein the operation control unit determines the bristle strength as soft bristle when the score for determining the bristle strength is equal to or less than a set value, and the operation control unit determines the bristle strength as hard bristle when the score for determining the bristle strength is greater than the set value.

7. The toothbrush type recommendation apparatus of claim 6, wherein when the bristle strength is determined as hard bristle, the operation control unit selects one of patterned bristles and elastic bristles as a toothbrush type according to presence of crooked teeth, presence of a wisdom tooth, and whether teeth scaling has been performed within one year.

8. The toothbrush type recommendation apparatus of claim 7, wherein the patterned bristles comprises a first bristle having a shape in which a cylinder and a cone are combined and a second bristle having a shape in which a polyhedron and a polygonal pyramid are combined, and the elastic bristles comprises a third bristle having a shape in which a cylinder and a cone are combined and a fourth bristle having a cylindrical shape.

9. The toothbrush type recommendation apparatus of claim 6, wherein when the bristle strength is determined as soft bristle, the operation control unit determines one of fine bristles and micro bristles as a toothbrush type according to presence of sensitive tooth, presence of a loose tooth, presence of bleeding gums, presence of swollen gums, and whether a user's age meets a set age condition.

10. The toothbrush type recommendation apparatus of claim 9, wherein the fine bristles comprises a bristle in which a cylinder and a cone are combined, and the micro bristles comprises a bristle having a cylindrical body and a plurality of tips.

11. The toothbrush type recommendation apparatus according to claim 6, wherein the soft bristle has a thickness equal to or less than a set value and have a circular cross section, and the hard bristle has a thickness equal to or greater than the set value or has a polygonal cross section.

12. The toothbrush type recommendation apparatus of claim 1, wherein the operation control unit outputs an address of an online shopping mall selling the selected toothbrush type to the output unit.

13. A toothbrush type recommendation server comprising: a communication unit; and a server management unit connected to the communication unit and configured to calculate a usage period of a toothbrush based on a selected toothbrush type and teeth-and-oral-related information, calculate a toothbrush replacement date based on the calculated usage period, and when a current date reaches at a toothbrush replacement notification date calculated using the toothbrush replacement date, transmit a toothbrush replacement timing notification message to a user terminal of a customer through the communication unit.

14. The toothbrush type recommendation server of claim 13, wherein when the current date does not reach the toothbrush replacement notification date, the server management unit predicts at least one tooth and oral disease with a high possibility of occurrence using the tooth and oral cavity related information, and transmits the predicted tooth and oral diseases to the user terminal using the communication unit.

15. The toothbrush type recommendation server of claim 14, wherein the teeth-and-oral-related information comprises at least one of the following: based on a selected bristle strength, a selected bristle shape, and a selected number of lines of bristles, a number of times a customer brushes teeth; an oral structure; presence of an artificial tooth; smoking; presence of at least one of calculus and plaque; bad breath; presence of abrasion in at least one of a cervical area and an apical area; presence of at least one of periodontal disease and dentin hypersensitivity; presence and degree of at least one of tooth decay and periodontal disease; presence and degree of at least one of calculus and plaque; and structure of an inner side of anterior teeth.

16. A control method for a toothbrush type recommendation apparatus, the method comprising: outputting, by an operation control unit of a user terminal, questionnaires having a question for determining the number of lines of bristles, a question for determining a strength of the bristles, and a question for determining a bristle shape to an output unit;
receiving, by the operation control unit, answers to the questionnaires from a user input unit to calculate a score for determining the number of lines of bristles and a score for determining a strength of the bristles;
determining, by the operation control unit, the number of lines of bristle and the bristle strength, which respectively corresponds to the calculated scores;
determining, by the operation control unit, a final shape of bristles based on the answer to the question for determining the shape of bristles in the questionnaires with respect to the determined bristle strength and select the determined final shape as a toothbrush type; and
outputting, by the operation control unit, the selected toothbrush type to the output unit.

17. The control method for claim 16, further comprising: transmitting, by the operation control unit, each answer for the questionnaires, a calculated score for determining the number of lines of bristles, a calculated score for determining a bristle strength, a determined number of lines of brittles, a determined bristle strength, and a determined bristle shape, and a selected toothbrush type to a toothbrush type recommendation server as tooth and oral information through the communication unit.

18. The control method for claim 17, further comprising: calculating, by a server management unit of the toothbrush type recommendation server, a usage period of the toothbrush based on a selected toothbrush type and teeth-and-oral-related information; calculating, by the server management unit, a toothbrush replacement date based on the calculated usage period; and when a current date reaches at a toothbrush replacement notification date calculated using the toothbrush replacement date, transmitting, by the server management unit, a toothbrush replacement timing notification message to the user terminal through the communication unit.

19. The control method for claim 18, further comprising: predicting, by the server management unit, at least one highly potential tooth and oral disease based on the tooth- and oral-related information when the current date does not reach the toothbrush replacement notification date; and transmitting, by the server management unit, the predicted tooth and oral disease to the user terminal using the communication unit.
